(19) United States
(12) Patent Application Publication
(10) Pub. No.: US 2012/0071212 A1
(43) Pub. Date: Mar. 22, 2012

(54) PORTABLE TERMINAL APPARATUS

(75) Inventors: Tomohiko Endo, Kanagawa (JP); Jun Anzai, Kanagawa (JP)

(73) Assignee: PANASONIC CORPORATION, Osaka (JP)

(21) Appl. No.: 13/322,415

(22) PCT Filed: Feb. 22, 2010
(86) PCT No.: PCT/JP2010/001157

§ 371 Date: Nov. 23, 2011

(30) Foreign Application Priority Data
Jun. 2, 2009 (JP) 2009-133135

(51) Int. Cl. H04B 1/38

(52) U.S. Cl. 455/566

(57) ABSTRACT

A portable terminal apparatus includes a first operation unit and a second operation unit. The first operation unit has an image area for displaying an image and an operation area for displaying operation keys. The second operation unit is configured to synchronously operate with the operation area of the first operation unit

### TECHNICAL FIELD

The present invention relates to a portable terminal apparatus, and more particularly, to a portable terminal apparatus including two different types of operation units.

### BACKGROUND ART

A user interface for facilitating operation of a functionally expanded portable phone has recently been developed. A portable phone KS shown in FIG. 14 includes a foldable portable phone body H, and the phone body H is equipped with an operation unit 1 for receiving key input operation, a display unit 2 for displaying a phone number of a called party, address book information, etc., a microphone 3, a receiver 4, and an antenna 5 provided on an upper portion of the phone body H.

The portable phone KS provides an operation unit display 6 (which is configured by visually displaying the operation unit 1) on the display unit 2. For example, a menu “Call” provided on the display unit 2 is displayed inverted, and a menu “Start Key” 7 provided on the operation unit display 6 is highlighted. Accordingly, the display is rendered visually recognizable (visual). Consequently, even elderly people, children, etc. can comprehend operation to be performed next and easily recognize keys necessary for the operation. However, descriptions stating that the display unit 2 is a touchscreen are not found (see, for example, Patent Document 1).

Further, an electronic device configured to automatically display software keys corresponding to physical keys according to ambient luminance and applicable to a portable phone is known. FIG. 15 is a diagram showing a display screen 8 on which the electronic device automatically displays a software keyboard corresponding to physical keys according to ambient luminance by detecting a quantity of external light.

FIG. 15(a) is an exemplified display screen showing that the software key display is not provided on the display screen 8. FIG. 15(b) is an exemplified display screen in which a group of software keys 10 and a power switch software key 9 are displayed on the display screen 8 because an external light level is a predetermined threshold level or less. When the software keys are displayed, physical keys provided on the electronic device body become disabled (see, for example, Patent Document 2).

### RELATED ART DOCUMENTS

### Patent Documents

Patent Document 1: JP-A-2002-344610
Patent Document 2: JP-A-2000-339089

### SUMMARY OF THE INVENTION

### Problem to be Solved by the Invention

However, in the portable phone described in Patent Document 1, the keys are assigned to respective unique meanings, whereby the usage is limited to an operational navigation for displaying keys valid for a certain screen. Specifically, a relationship between physical keys (mechanical keys) and software keys (keys on a touchscreen: touch keys) is fixed, and the physical keys and the software keys do not synchronously operate together.

In the electronic device described in Patent Document 2, touch keys or physical keys are exclusively used. In a dark environment, only software keys on an LCD (a display screen) are operable. In contrast, in a bright environment, only physical keys are operable. That is, both of the touch keys and the physical keys are not operable simultaneously. In this case, the touchscreen makes the user easy to perform sensory (rough) operation. However, the touchscreen is not suited for operation like elaborate fine adjustment. The reverse can be said to apply to the physical keys.

The present invention has been made in view of the above circumstance and provides a portable terminal apparatus that provides a display screen which makes a user intuitively understand that two types of operation units synchronously work together and that causes the two types of operation units (e.g., a touchscreen and physical keys) to synchronously work together.

### Means for Solving the Problem

A portable terminal apparatus of the present invention includes: a first operation unit having an image area for displaying an image and an operation area for displaying operation keys; and a second operation unit configured to synchronously operate with the operation area of the first operation unit.

With this configuration, the portable terminal apparatus can let the user intuitively comprehend that the two types of operation units synchronously operate together.

In the portable terminal apparatus of the present invention, the second operation unit disables an input at a part of the second operation unit corresponding to the image area of the first operation unit and enables an input at a part of the second operation unit corresponding to the operation area of the first operation unit.

With this configuration, since the input at the part of the second operation unit corresponding to the operation area of the first operation unit is enabled, the user can make a key input in response to the operated key in the operation area while viewing the image area.

In the portable terminal apparatus of the present invention, the second operation unit illuminates a backlight for the part of the second operation unit corresponding to the operation area of the first operation unit and does not illuminate a backlight for the part of the second operation unit corresponding to the image area of the first operation unit.

With this configuration, the user can easily and visibly recognize that the two types of operation units synchronously operate together.

In the portable terminal apparatus of the present invention, the second operation unit accepts operation of a pointer at the part of the second operation unit corresponding to the image area of the first operation unit.

With this configuration, since operation of the pointer is received at the part of the second operation unit corresponding to the image area of the first operation unit, the part corresponding to the image area and to be disabled can be effectively utilized.

Moreover, in the portable terminal apparatus of the present invention, the first operation unit includes a touchscreen, and the second operation unit includes hardware keys.

With this configuration, the user can perform intuitive operation or rough operation by the touchscreen, and also can perform quantitative operation or fine adjustment operation by means of the hardware keys.

The portable terminal apparatus of the present invention also includes a synchronous operation control unit configured to compare data received by the first and second operation unit with a status which is currently displayed on the first operation unit, and configured to determine whether the data are enabled or disabled.

With this configuration, the data received by the first and second operation unit are compared with the status which is currently displayed on the first operation unit, and the enable/disable determination is made. Hence, a display screen and a layout of keys to be operated can be changed in synchronism with the user's operation.

In the portable terminal apparatus of the present invention, the synchronous operation control unit sets a part of the second operation area positionally corresponding to the operation area of the first operation unit as an enabled portion, and sets a part of the second operation unit positionally corresponding to the image area of the first operation unit as a disabled portion.

With this configuration, the part of the second operation unit positionally corresponding to the operation area is set as the enabled portion. Further, the part of the second operation unit positionally corresponding to the image area is set as the disabled portion. Therefore, positions with easy key input can be set as the enabled portion in synchronism with user's operation.

In the portable terminal apparatus of the present invention, when movement of the image area of the first operation unit is detected, the synchronous operation control unit shifts the operation area and switches the enabled portion and the disabled portion such that the disabled portion positionally corresponds to the image area and such that the enabled portion positionally corresponds to the operation area.

With this configuration, when the movement of the image area is detected, the enabled portion and the disabled portion are switched such that the disabled portion positionally corresponds to the image area and the enabled portion positionally corresponds to the operation area, whereby the user can intuitively ascertain that the display image and input keys synchronously operate together.

In the portable terminal apparatus of the p′resent invention, when rotation of the image area of the first operation unit is detected, the synchronous operation control unit rotates the operation area and switches the enabled portion and the disabled portion, so as to correspond to a zenith direction of the image area.

With this configuration, when rotation of the image area is detected, the operation area is rotated and the enabled portion and the disabled portion are switched, so as to correspond to the zenith direction of the image area. Hence, the user can intuitively recognize that the display image and the input keys synchronously operate together.

In the portable terminal apparatus of the present invention, when a press to the disabled portion of the second operation unit is detected, the synchronous operation control unit switches the disabled portion and the enabled portion and moves the image area and the operation area such that the image area positionally corresponds to the disabled portion and such that the operation area positionally corresponds to the enabled portion.

With this configuration, when a press to the disabled portion is detected, the disabled portion and the enabled portion are switched, and the image area and the operation area are moved such that the image area positionally corresponds to the disabled portion and that the operation area positionally corresponds to the enabled portion. Hence, a part of the operation unit to become a disabled portion in correspondence to the image area can be effectively utilized.

In the portable terminal apparatus of the present invention, the second operation unit includes a rotary selector. When the operation area of the first operation unit positionally corresponds to the rotary selector, the synchronous operation control unit enables operation to the rotary selector.

By means of the configuration, when the operation area positionally corresponds to the rotary selector, operation of the operation area of the first operation unit intended for the rotary selector is enabled, the user can easily operate the rotary selector while viewing the image area.

### ADVANTAGES OF THE INVENTION

As has been described above, the portable terminal apparatus of the present invention has at least two types of operation units and can make the user intuitively understand that the two types of operation units synchronously work together. Therefore, operability of the portable terminal apparatus can be enhanced.

### BRIEF DESCRIPTION OF THE DRAWINGS

FIG. 1 is a block diagram of a portable terminal apparatus including hardware keys that synchronously operate with a touchscreen according to an embodiment of the present invention.

FIG. 2 is a configuration diagram of the portable terminal apparatus including the hardware keys that synchronously operate with the touchscreen according to the embodiment of the present invention.

FIG. 3 shows diagrams for explaining switching of an enabled portion by sliding action in the portable terminal apparatus according to the embodiment of the present invention.

FIG. 4 shows diagrams for explaining switching of the enabled portion in a zenith direction associated with switching of the zenith direction caused by rotational operation, in the portable terminal apparatus according to the embodiment of the present invention.

FIG. 5 is a diagram for explaining utilization of a disabled portion (utilizing the disabled portion as a sensor device) in the portable terminal apparatus according to the embodiment of the present invention.

FIG. 6 corresponds to diagrams for explaining utilization of the disabled portion (switching between an image area and enabled portion synchronous operation areas is performed by a press on the disabled portion), in the portable terminal apparatus according to the embodiment of the present invention.

FIG. 7 is a diagram for explaining an example of implementation of the portable terminal apparatus of the embodiment according to the present invention (a thumbnail display of a picture).

FIG. 8 is a diagram for explaining an example of implementation of the portable terminal apparatus according to the embodiment of the present invention (a thumbnail display of a picture).

FIG. 9 is a diagram showing operation for displaying a list in the portable terminal apparatus according to the embodiment of the present invention.

FIG. 10 shows diagrams illustrating a shift of a selected frame to an edit screen in the portable terminal apparatus according to the embodiment of the present invention.

FIG. 11 shows diagrams illustrating showing a shift of the selected frame to an edit screen in the portable apparatus according to the embodiment of the present invention.

FIG. 12 is a diagram showing a rotary selector of the portable terminal apparatus according to the embodiment of the present invention.

FIG. 13 is a diagram showing the rotary selector of the portable terminal apparatus according to the embodiment of the present invention.

FIG. 14 is an external view of an overall configuration of a related art portable phone.

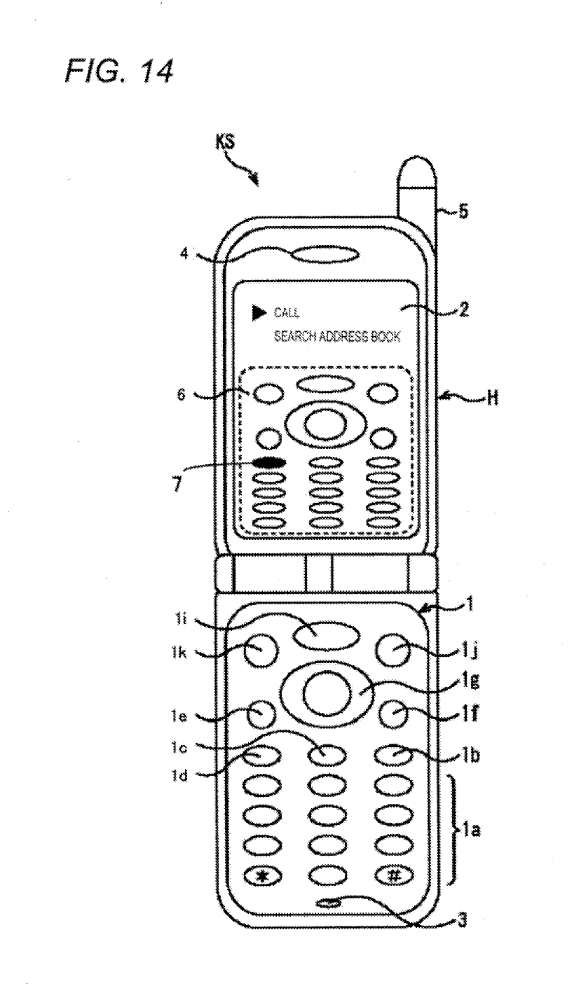

FIG. 15 illustrations of a display screen of a related art electronic device.

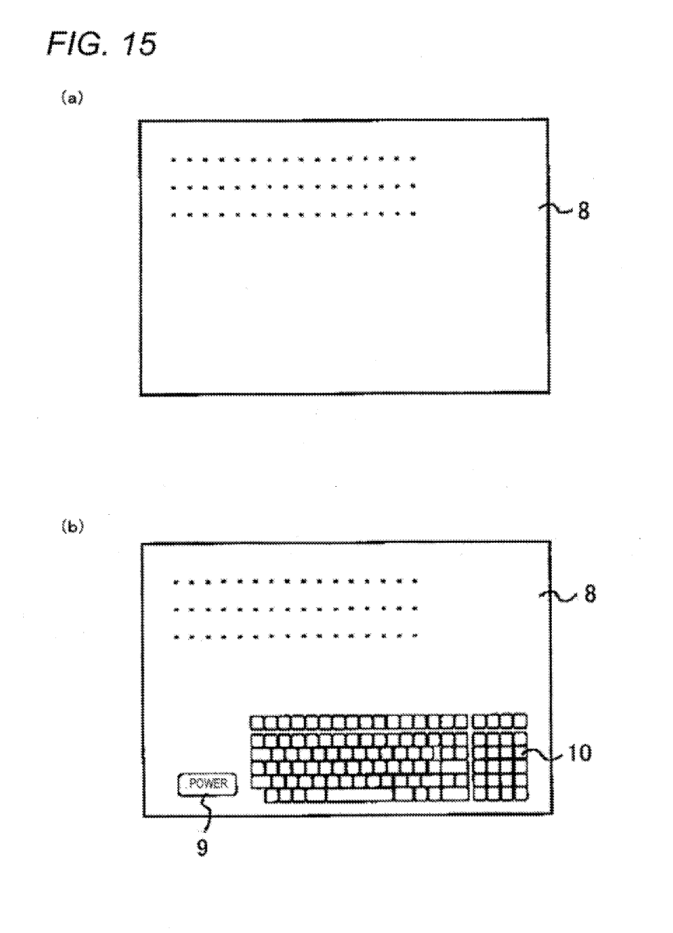

### MODE FOR CARRYING OUT THE INVENTION

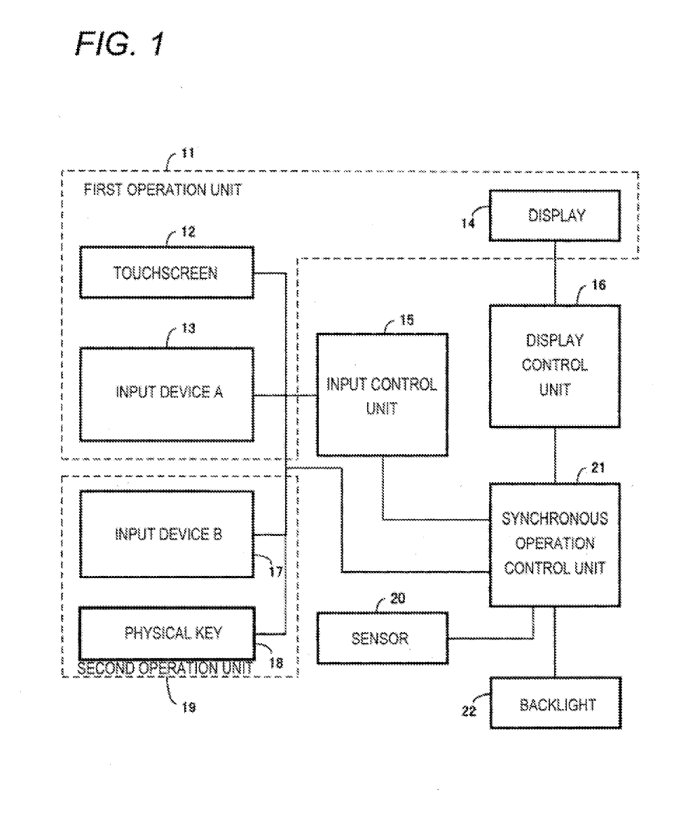

FIG. 1 is a unit diagram of a portable terminal apparatus including hardware keys configured to synchronously operate with a touchscreen of an embodiment of the present invention. The portable terminal apparatus includes a first operation unit 11, a second operation unit 19, an input control unit 15, and a synchronous operation control unit 21, and a sensor 20.

The first operation unit 11 includes a touchscreen 12 including a touch sensor, an input device A13 including a key sensor, a rotary selector sensor, or a touch sensor, and a display 14 configured to display an image. The second operation unit 19 includes an input device B17 including a static sensor, an optical sensor, or a pressure sensor, and physical keys (hardware keys) 18. The input control unit 15 receives an input performed by the touchscreen 12, or the like. A display control unit 16 controls an indication of the display 14. The synchronous operation control unit 21 synchronizes the input and the display. The sensor 20 includes an acceleration sensor or a gyro-sensor.

Functions of respective units are now described. The touchscreen 12 corresponds to a block having a sensor for a touchscreen display. The input device A13 corresponds to a block having an input device configured to synchronously operate with displayed contents on the touchscreen display.

The input device B17 corresponds to a block having an input device for displaying a pointer, or the like, for activating an input area that has been disabled by the synchronous operation control unit 21. The physical keys (hardware keys) 18 are configured by mechanical hardware keys, like numerical pads. The input control unit 15 receives signals output from the touchscreen 12, the input device A13, and the input device 817; subjects the received signals to shaping operations, such as interpolation, chattering, and noise removal; and transfers the processed data to the synchronous operation control unit 21. The acceleration sensor or the gyro-sensor included in the sensor 20 detects information about an orientation, attitude, or the like, of the terminal apparatus, and sends the information to the synchronous operation control unit 21.

The synchronous operation control unit 21 compares the data received by the input control unit 15 with a status currently displayed on the display 14, thereby making an enable or disable determination. Further, the synchronous operation control unit determines whether or not transmission of data to the display control unit 16 is possible. In accordance with information from the input control unit 15 and information from the acceleration sensor or the gyro-sensor included in the sensor 20, a synchronous operation screen is configured, and the thus-configured screen is sent to the display control unit 16.

The display control unit 16 draws an image on the display 14 according to a screen configuration notified by the synchronous operation control unit 21. The display 14 displays a screen designated by the display control unit 16.

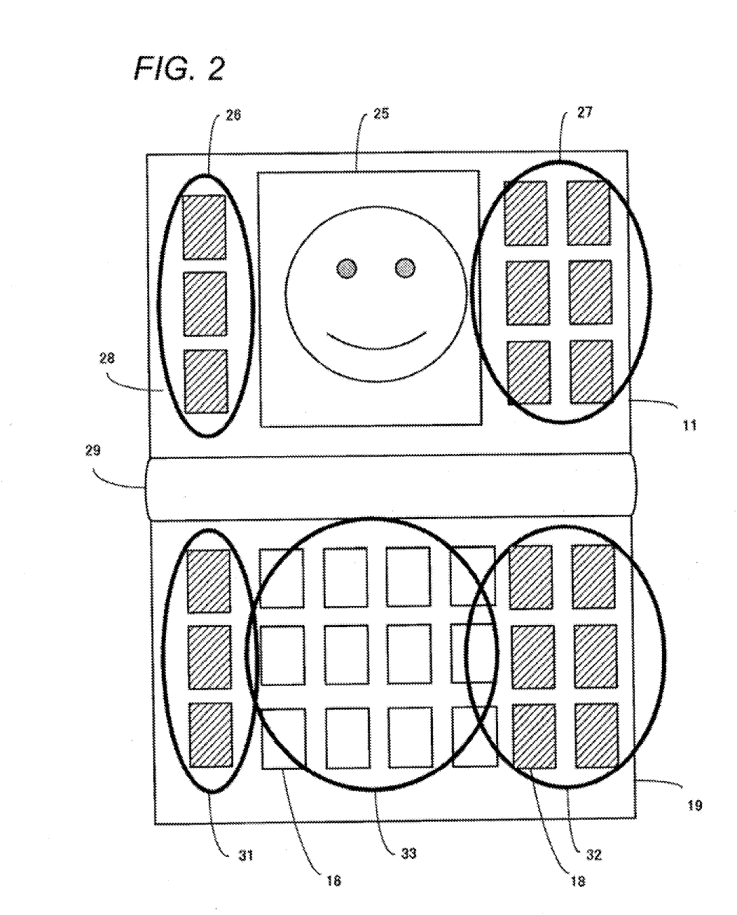

FIG. 2 is a schematic view of the portable terminal apparatus having the hardware keys (physical keys) that synchronously operate with the touchscreen of the embodiment of the present invention. The portable terminal apparatus includes the first operation unit 11, the second operation unit 19, and a hinge 29 that connects and can open and close the first operation unit 11 to the second operation unit 19.

The first operation unit 11 includes a touchscreen 28 (that also doubles as the touchscreen 12 and the display 14 in FIG. 1). Displayed on the touchscreen 28 are an image area 25 where an image is displayed and enabled portion synchronous operation areas 26 and 27 that are operation areas where the operation keys (touch keys) are to be displayed and where input operation is enabled. Further, the input device A13 shown in FIG. 1 is also provided in the first operation unit 11.

The second operation unit 19 is connected to the first operation unit 11 in a foldable manner by way of the hinge 29 and also has the physical keys 18. Enabled portions 31 and 32 where key operation becomes enabled are provided at positions corresponding to the enabled portion synchronous operation areas 26 and 27 displayed on the touchscreen 28. The disabled portion 33 where key operation is disabled is provided at the position on the touchscreen 28 corresponding to the image area 25. The enabled portions 31, 32 and the disabled portion 33 each are formed from different physical keys 18. Further, an input device B17 shown in FIG. 1 is also provided in the second operation unit 19.

As mentioned above, the present embodiment provides a UI display that enables the user to visually, intuitively understand that a group of user interfaces (UI) shown in the enabled portion synchronous operation areas 26 and 27 and the enabled portions 31 and 32 synchronously operate together. A fingertip is brought into contact with the touchscreen 28, and the image area 25 is moved in an arbitrary direction. The enabled portion synchronous operation areas 26 and 27 displayed in a preceding status are hidden, and newly displayed areas come into the enabled portion synchronous operation areas 26 and 27.

In synchronism with the operations, the enabled portions 31 and 32 that synchronously operate with the enabled portion synchronous operation areas 26 and 27 of the touchscreen 28 and the disabled portion 33 are switched. The physical keys 18 that synchronously operate with the enabled portion synchronous operation areas 26 and 27 come into the enabled portions 31 and 32. In an example in which the entirety of the second operation unit 19 is built from a touchscreen, the input UIs that synchronously operate with the enabled portion synchronous operation areas 26 and 27 and appear on the display come into the enabled portions 31 and 32.

Processing performed by the respective blocks shown in FIG. 1 in response to the above-mentioned operations are now described. The input control unit 15 accepts a contact input, such as a contact by a fingertip with the touchscreen 12 (an operational input, such as a slide and a scratch). The synchronous operation control unit 21 compares data based on the contact input received from the input control unit 15 with a status (a layout of the image area 25 and that of the enabled portion synchronous operation areas 26 and 27) currently displayed on the touchscreen 28 (the display 14 shown in FIG. 1), thereby determining whether to enable or disable the touchscreen and also determining whether or not to notify the display control unit 16 of the data. Now, an enable determination is a determination that data involves a necessity to change a display of the touchscreen 28. A disable determination is a determination that data do not involve a necessity to change the display of the touchscreen 28.

The synchronous operation control unit 21 sends a command to a backlight 22, thereby illuminating only the backlights of the enabled portions 31 and 32 (or extinguish the backlight of the disabled portion 33). This also enables the user to easily, visibly understand that the enabled portions 31 and 32 provide enabled keys and the disabled portion 33 provides disabled keys. Further, the user can also easily, visibly become aware that the two types of operation units synchronously operate together.

According to the screen configuration corresponding to the enable determination notified by the synchronous operation control unit 21, the display control unit 16 draws an image on the touchscreen 28 (the display 14 shown in FIG. 1). Specifically, an image is drawn on the touchscreen 28 (the display 14 in FIG. 1) according to the image area 25 corresponding to the enable determination and the layout of the enabled portion synchronous operation areas 26 and 27. The touchscreen 28 (the display 14 in FIG. 1) displays a screen (the image area 25 and the enabled portion synchronous operation areas 26 and 27) designated by the display control unit 16.

At this time, the synchronous operation control unit 21 sorts the physical keys 18 of the second operation unit 19 into the enabled portions 31 and 32 or the disabled portion 33 according to the image area 25 corresponding to the enable determination and the layout of the enabled portion synchronous operation areas 26 and 27. Specifically, the synchronous operation control unit 21 sets areas on the second operation unit 19, which positionally correspond to the enabled portion synchronous operation areas 26 and 27 of the first operation unit 11, to the enabled portions 31 and 32; and also sets an area on the second operation unit 19, which positionally corresponds to the image area 25 of the first operation unit 11, to the disabled portion 33.

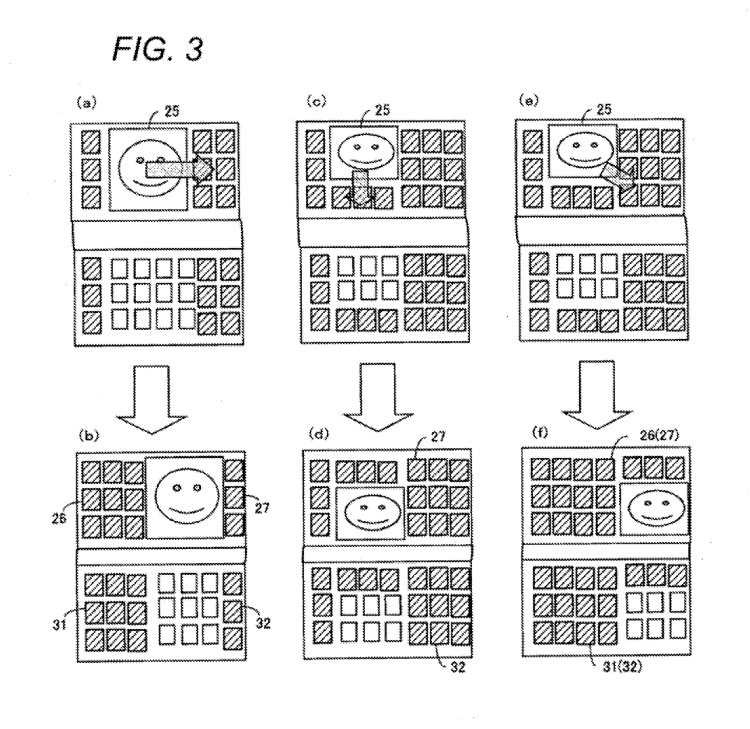

FIG. 3 corresponds to illustrations for describing switching of the enabled portion performed by means of sliding action in the portable terminal apparatus having hardware keys that synchronously operate with the touchscreen of the embodiment. A fingertip is brought into contact with the touchscreen, and the display image (image area) 25 is slid right and left as shown in FIG. 3(a), whereupon the enable keys (enabled portions) 31 and 32 and the synchronous operation units (the enabled portion synchronous operation areas) 26 and 27 are switched as shown in FIG. 3(b). Further, when the display image 25 is slid up and down as shown in FIG. 3(c), the enable keys 31 (32) and the synchronous operation unit 26(27) are switched as shown in FIG. 3(d). Likewise, the display image 25 is obliquely slid as shown in FIG. 3(e), the enable keys 31 (32) and the synchronous operation unit 26 (27) are switched as shown in FIG. 3(f).

Specifically, when detected movement of the image area 25 of the first operation unit 11, the synchronous operation control unit 21 shifts the enabled portion synchronous operation areas 26 and 27, thereby switching the enabled portions 31 and 32 and the disabled portion 33 so as to positionally correspond to the image area 25 and the enabled portion synchronous operation areas 26 and 27.

As mentioned above, the portable terminal apparatus of the embodiment successfully enables synchronism between intuitive operation performed by a touch on the touch key of the touchscreen (the enabled portion synchronous operation area) and operation of the numerical keypads, so that operability of the portable terminal apparatus can be enhanced. Specifically, when the image is moved by means of operation, such as a slide by a finger over the touchscreen, operable hardware keys are also moved (synchronously) so as not to overlay the image. Thus, it is also possible to enhance ease of operation of the numerical key pads while ease of intuitive operation performed by means of the touchscreen is assured.

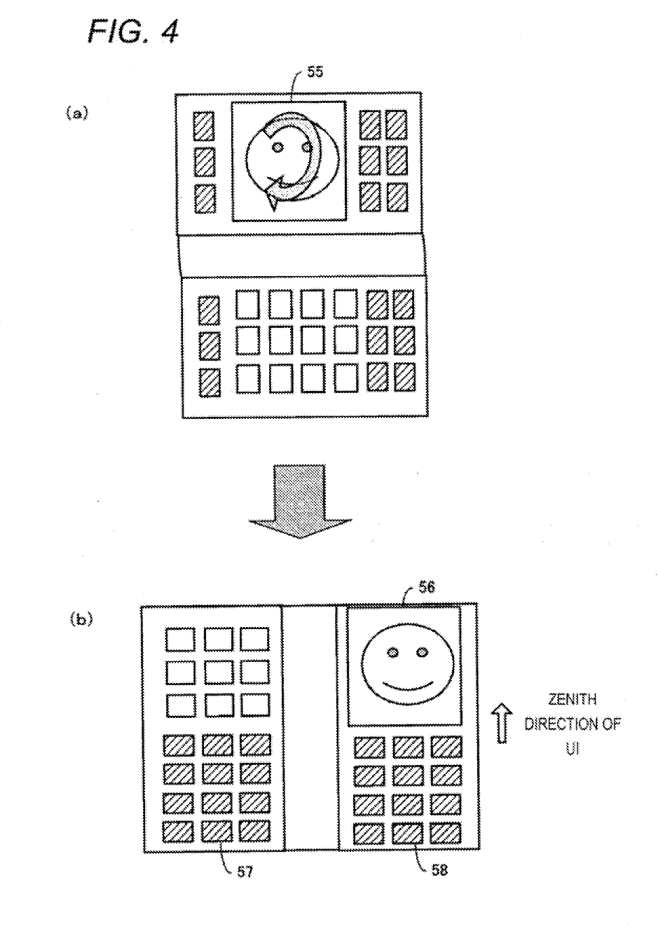

FIG. 4 corresponds to illustrations for describing switching of the enabled portions associated with switching of the zenith direction caused by rotational operation (or detection of an orientation performed by a sensor device) in the portable terminal apparatus having hardware keys that synchronously operate with the touchscreen of the embodiment.

As shown in FIG. 4(a), the sensor 20 (FIG. 1) detects rotation of the portable terminal apparatus, that is, rotation of a display image (image area) 55, thereby detecting the zenith direction of the image and the operation unit. As shown in FIG. 4(b), the display control unit 16 switches the zenith direction of a display image 56 and touch keys (the enabled portion synchronous operation area) 58. Further, the synchronous operation control unit 21 switches hardware keys (physical keys) 57 to a position corresponding to the touch keys 58.

When detected rotation of the image area 55 of the first operation unit 11, the synchronous operation control unit 21 rotates the image area 55 so as to match the zenith direction of the image area 55, thereby switching the enabled portions and the disabled portion.

As mentioned above, the touch keys 58 and the hardware keys 57 can operate in a cooperative manner and in a synchronous manner, whereby active areas for key operations can be freely arranged according to the way the user holds the portable terminal apparatus. Thus, touch key operation and hardware key operation can be flexibly switched according to an objective of operation.

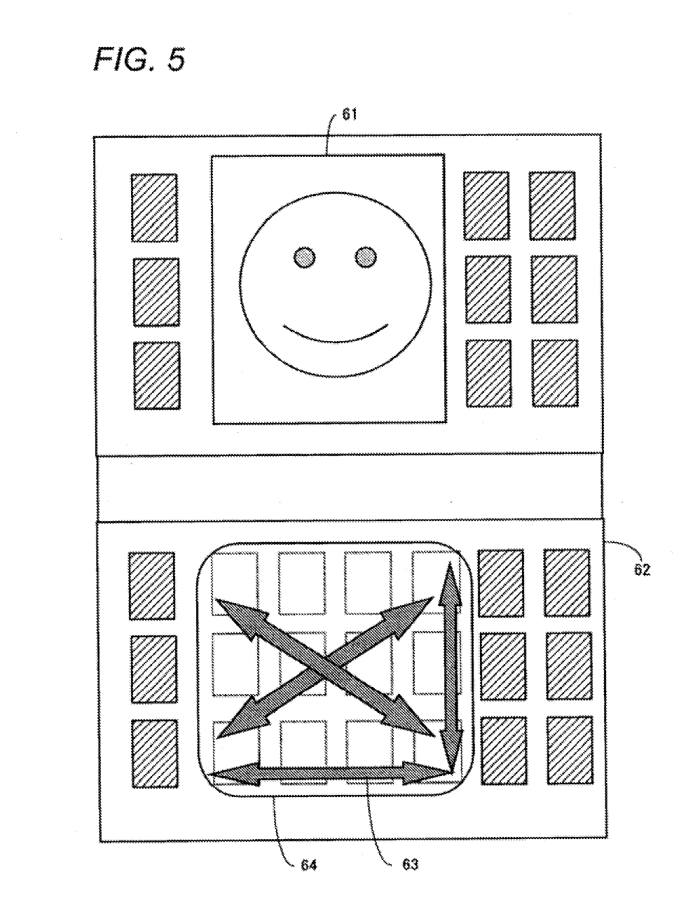

FIG. 5 is an illustration for describing utilization of the disabled portion (utilizing the disabled portion as a sensor device) in the portable terminal apparatus having hardware keys that synchronously operate with the touchscreen of the embodiment. In the embodiment, an input device 62 of the second operation unit 19 (an input device B17 in FIG. 1) is multilayered, whereby a sensor device 63 is put on an upper or lower surface of the input device 62. When the user touches an area that has come into a disabled portion 64 in cooperation with a display image (an image area) 61, the sensor device 63 detects the operation performed by the user and enables the disabled portion 64 so as to enable performance of pointer operation. The sensor device 63 is put on the upper or lower surface of the input device 62 as mentioned above, thereby enabling the disabled portion 64 according to predetermined conditions, so that the disabled portion 64 can also be effectively utilized.

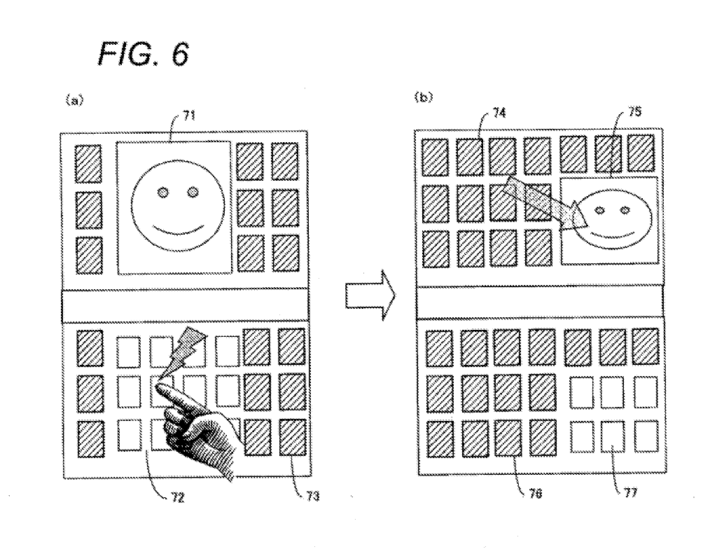

FIG. 6 corresponds to illustrations for describing utilization of the disabled portion (switching between the image area and the enabled portion synchronous operation areas is performed by a press on the disabled portion) in the portable terminal apparatus having hardware keys that synchronously operate with the touchscreen of the present embodiment. As shown in FIG. 6(a), a disabled portion (physical keys) 72 that synchronously operate with a software key unit hidden behind an image area 71 remains operationally disabled. However, when the user presses any point in the disabled portion 72, a display image (the image area) 75 automatically moves in such a way that the portion to operate synchronously with the disabled portion 72 changes into the enabled portion 76, as shown in FIG. 6(b). The sensor device 63 described by reference to FIG. 5, or the like, can be used for detecting press action.

Specifically, when detected a press on the disabled portion 72 of the second operation unit 19, the synchronous operation control unit 21 switches the disabled portion 72 and the enabled portion 73, thereby moving the image area 75 and an enabled portion synchronous operation area (a synchronous operation unit) 74 so as to positionally correspond to a disabled portion 77 and an enabled portion 76.

According to the present embodiment, when a press on the disabled portion 72 is detected, the disabled portion 72 and the enabled portion 73 are switched. The image area 75 and the enabled portion synchronous operation area (the synchronous operation unit) 74 are moved so as to positionally correspond to the disabled portion 77 and the enabled portion 76. Therefore, the disabled portion 72 corresponding to the image area 71 can be effectively utilized.

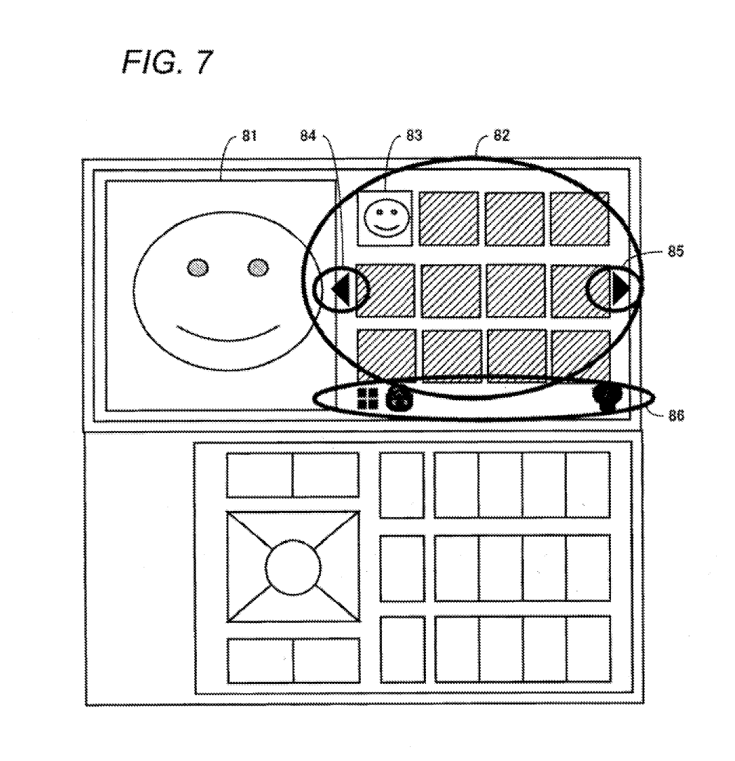

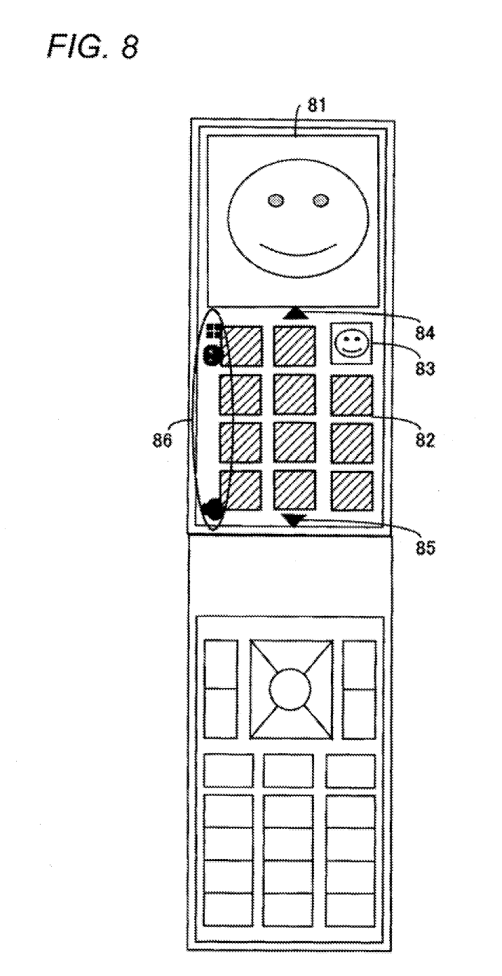

FIGS. 7 and 8 are illustrations for describing example implementation of the portable terminal apparatus of the embodiment of the present invention (a thumbnail display of a picture). FIG. 7 shows a basic screen (oriented in a landscape position), whilst FIG. 8 shows a basic screen (oriented in a portrait position). A status or function of an image to be displayed is selected by means of a status icon or a function select icon 86. Further, an image to be displayed in a frame list 82 is searched by use of a preceding page button 84 or a subsequent page button 85. When an image 83 desired to be displayed in the frame list 82 is focused, an image of the focused frame appears on an image area 81.

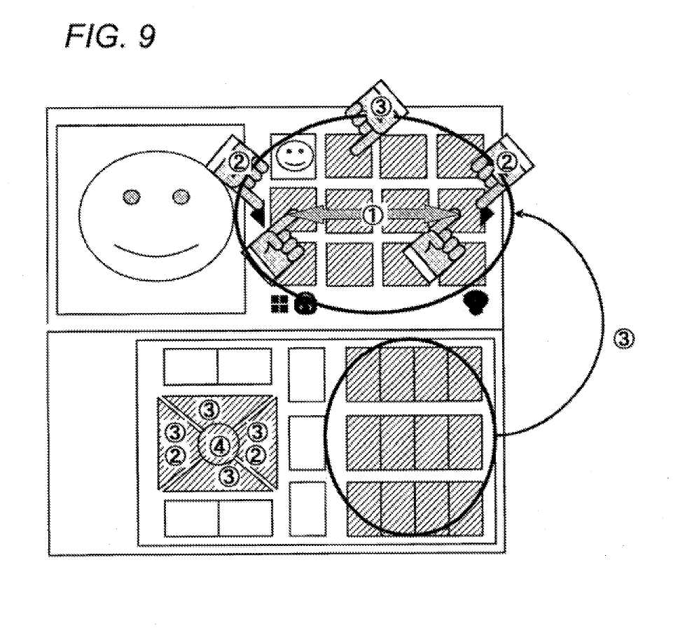

FIG. 9 is an illustration for explaining example implementation of the portable terminal apparatus of the present embodiment (a thumbnail display of the picture). In particular, the illustration shows operation to be performed when a list display (a content list and a frame list for editing motion pictures) is provided. In relation to operation, for example, (1) a page is moved by means of right-left sliding action (flicking action). (2) A page is switched by means of tapping the preceding-subsequent page button (the page can also be switched by means of a press on a right-left navigation key for a long period of time). (3) A frame to be focused is selected (the frame can also be selected by pressing the up-down/right-left navigation key for a short period of time, and the frame is synchronized positions of the numerical keypads), whereby a focused image is displayed in the image area. The enabled portion synchronous operation areas of the touchscreen are linked to areas located at corresponding positions in the enabled portion of the input device.

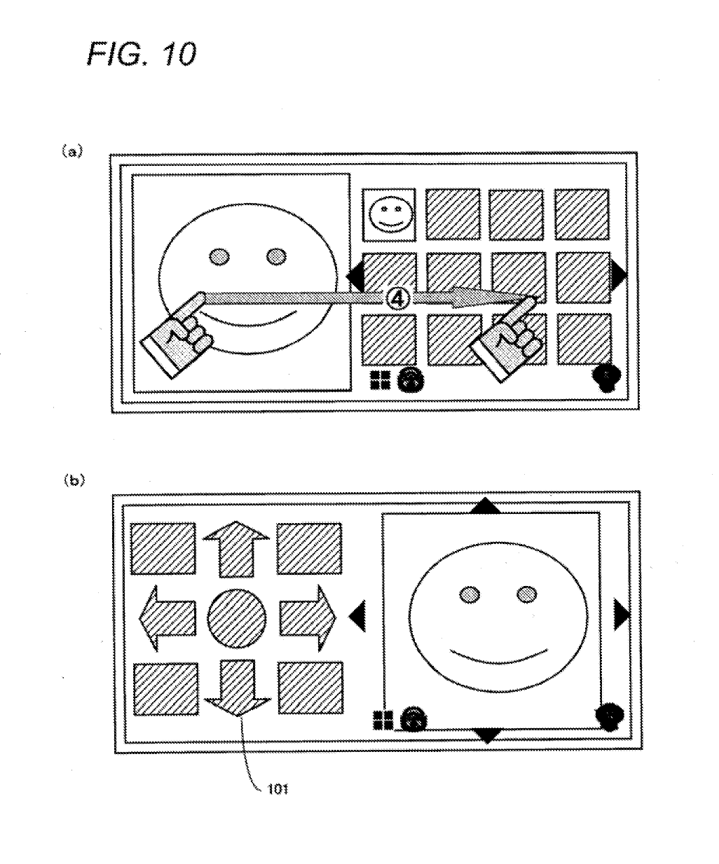

FIG. 10 corresponds to illustrations for explaining an example implementation of the portable terminal apparatus of the present embodiment (a thumbnail display of pictures), particularly showing a shift of a selected frame to an edit screen. As shown in FIG. 10(a), (4) the focused image is slid right (or S1 key is pressed for a long period of time), whereby an edit screen function key 101 linked to the navigation key appears from a position below the slid image, as shown in FIG. 10(b).

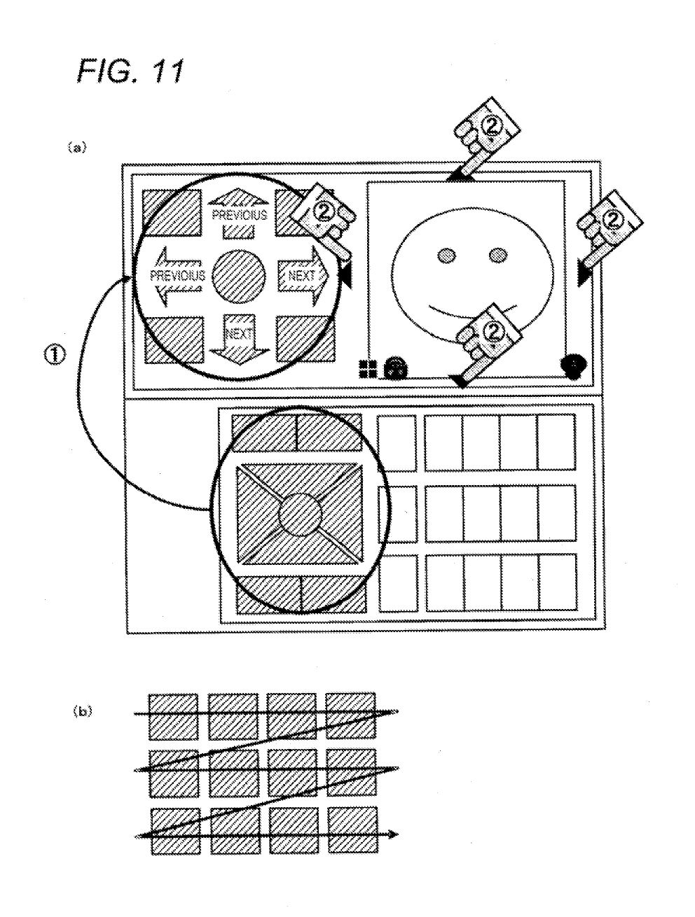

FIG. 11 corresponds to illustrations for explaining an example implementation of the portable terminal apparatus of the present embodiment (a thumbnail display of pictures), particularly showing the edit screen for a selected frame. As shown in FIG. 11(a), (1) selecting a function is in synchronism with action of a scroll key located at a corresponding position. (2) an upper left key synchronously operates with a preceding image, and a lower right key synchronously operates with a subsequent image. Further, selection of a function also synchronously operates with the up, down, right, and left keys. FIG. 11(b) shows a sequence of scroll of an image.

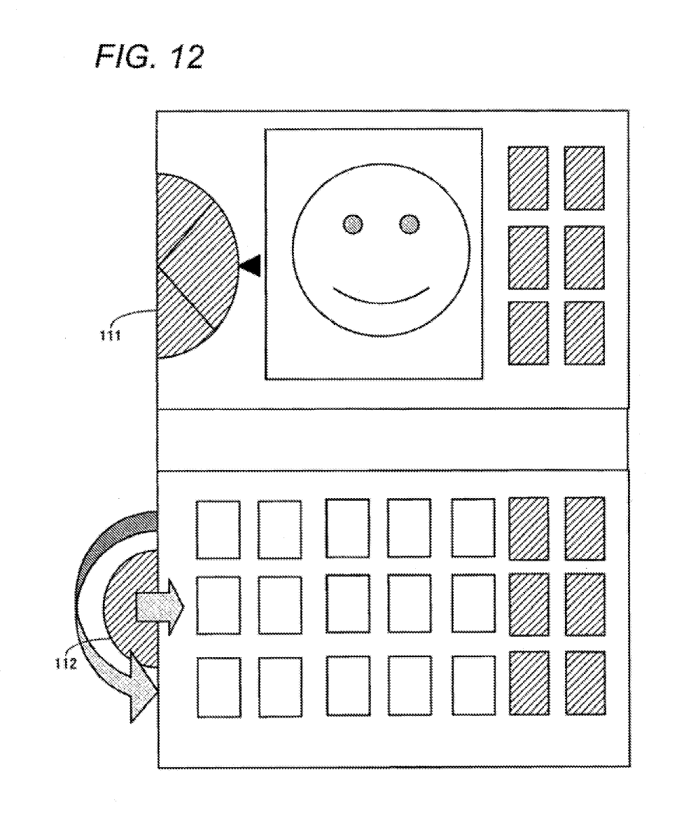

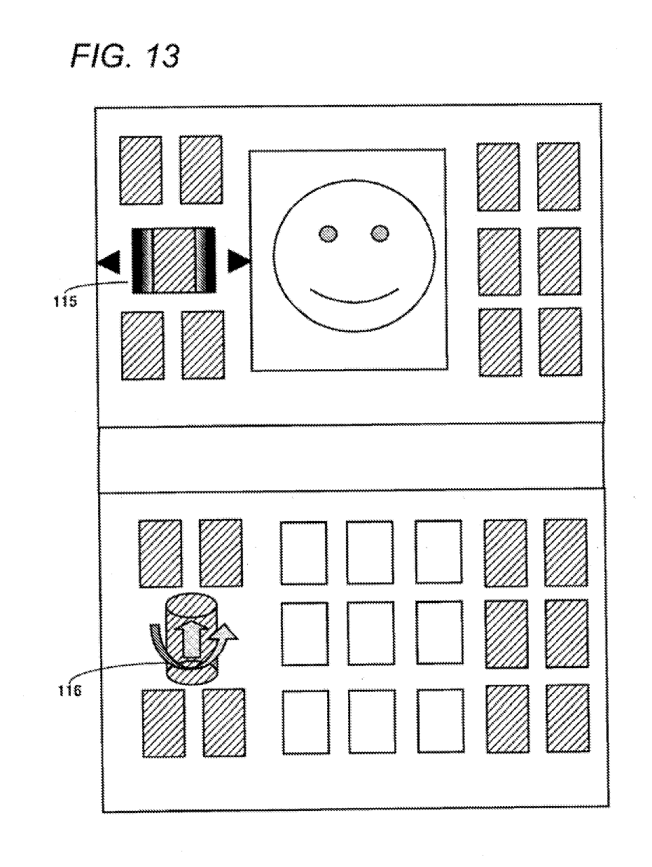

FIGS. 12 and 13 show rotary selectors of the portable terminal apparatus having hardware keys that operate synchronously with the touchscreen of the portable terminal apparatus of the present embodiment. In FIG. 12, a selector synchronous operation unit 111 synchronously operates with rotation of a rotary selector 112 and makes a determination when touched or synchronously pressed. The rotary selector 112 makes a selection when rotated and makes a determination when pressed. In FIG. 13, a selector synchronous operation unit 115 synchronously operates with rotation of a rotary selector 116 and makes a determination when touched or synchronously pressed. The rotary selector 116 makes a selection when rotated and makes a determination when pressed.

According to the present embodiment, when the selector synchronous operation units 111 and 115 positionally correspond to the rotary selectors 112 and 116, the synchronous operation control unit 21 enables operation of the selector synchronous operation units intended for the rotary selectors 112 and 116. Hence, the user can easily operate the rotary selectors 112 and 116 while viewing a display image.

As mentioned above, the portable terminal apparatus of the present embodiment makes it possible to let the user intuitively comprehend that the apparatus has at least two types of operation units and that the two types of operation units synchronously operate together. Therefore, it is possible to enhance operability of the portable terminal apparatus.

Further, by means of the contrivance made to a display layout, the two types of operation units let the user intuitively comprehend that synchronous operation is carried out. To this end, specifics displayed at a certain position on the touchscreen, for example, can be changed according to the application of the screen. Therefore, the operation unit displayed at a certain position can be flexibly changed to an operation unit commensurate with a screen status of the touchscreen, whereby operability of the portable terminal apparatus can be enhanced. Power of expression of the portable terminal apparatus can also be enhanced.

According to the present invention, the portable terminal apparatus makes it possible to let the user intuitively comprehend that the two types of operation units synchronously operate together. Therefore, for example, one of the operation units performs rough selection, and the other operation unit performs fine adjustment. Thus, it is possible to enhance ease to ascertain synchronous operation of the two operation units that differ from each other in terms of characteristics.

The present invention is not limited to the portable terminal apparatus described in connection with the embodiments and is scheduled to undergo alterations or applications contrived by the person skilled in the art according to the descriptions of the specification and the well-known techniques. The alterations and applications shall fall within a range where protection of the present invention is sought.

The present patent application is based on Japanese Patent Application No. 2009-133135 filed on Jun. 2, 2009, the entire subject matter of which is incorporated herein by reference.

### INDUSTRIAL APPLICABILITY

The present invention provides a portable terminal apparatus that provides a display screen that makes the user intuitively comprehend that two types of operation units synchronously operate together and that causes the two types of operation units (e.g., a touchscreen and physical keys, and the like) to operate together.

### DESCRIPTION OF REFERENCE SIGNS

1 OPERATION UNIT
2 DISPLAY UNIT
3 MICROPHONE
4 RECEIVER
5 ANTENNA
6 OPERATION UNIT DISPLAY
7 START KEY
8 DISPLAY SCREEN
9 POWER SWITCH SOFTWARE KEY
10 GROUP OF SOFTWARE KEYS
11 FIRST OPERATION UNIT
12 TOUCHSCREEN
13 INPUT DEVICE A
14 DISPLAY
15 INPUT CONTROL UNIT
16 DISPLAY CONTROL UNIT
17 INPUT DEVICE B
18, 57 PHYSICAL KEY (HARDWARE KEY)
19 SECOND OPERATION UNIT
20 SENSOR
21 SYNCHRONOUS OPERATION CONTROL UNIT
22 BACKLIGHT
25 IMAGE AREA (DISPLAY IMAGE)
26, 27, 74 ENABLED PORTION SYNCHRONOUS OPERATION AREA (SYNCHRONOUS OPERATION UNIT)
28 TOUCHSCREEN
29 HINGE
31, 32, 73, 76 ENABLE KEY (ENABLED PORTION)
33, 64, 72, 77 DISABLED PORTION
55, 56, 61, 71, 75, 81 IMAGE AREA (DISPLAY IMAGE)
58 SOFTWARE KEY (TOUCH KEY)
63 SENSOR DEVICE
82 FRAME LIST
83 IMAGE
84, 85 PRECEDING PAGE BUTTON, SUBSEQUENT PAGE BUTTON
101 EDIT SCREEN FUNCTION KEY
111, 115 SELECTOR SYNCHRONOUS OPERATION UNIT
112, 116 ROTARY SELECTOR

1. A portable terminal apparatus comprising:
a first operation unit having an image area for displaying an image and an operation area for displaying operation keys; and
a second operation unit configured to synchronously operate with the operation area of the first operation unit so as to disable an input at a part of the second operation unit corresponding to the image area of the first operation unit and to enable an input at a part of the second operation unit corresponding to the operation area of the first operation unit.

2. (canceled)

3. The portable terminal apparatus according to claim 1,
wherein the second operation unit illuminates a backlight for the part of the second operation unit corresponding to the operation area of the first operation unit and does not illuminate a backlight for the part of the second operation unit corresponding to the image area of the first operation unit.

4. The portable terminal apparatus according to claim 1,
wherein the second operation unit accepts operation of a pointer at the part of the second operation unit corresponding to the image area of the first operation unit.

5. (canceled)

6. The portable terminal apparatus according to claim 1, comprising:
a synchronous operation control unit configured to compare data received by the first and second operation unit with a status which is currently displayed on the first operation unit, and configured to determine whether the data are enabled or disabled.

7. The portable terminal apparatus according to claim 6,
wherein the synchronous operation control unit sets a part of the second operation area positionally corresponding to the operation area of the first operation unit as an enabled portion, and sets a part of the second operation unit positionally corresponding to the image area of the first operation unit as a disabled portion.

8. The portable terminal apparatus according to claim 7,
wherein when movement of the image area of the first operation unit is detected, the synchronous operation control unit shifts the operation area and switches the enabled portion and the disabled portion such that the disabled portion positionally corresponds to the image area and such that the enabled portion positionally corresponds to the operation area.

9. The portable terminal apparatus according to claim 7,
wherein when rotation of the image area of the first operation unit is detected, the synchronous operation control unit rotates the operation area and switches the enabled portion and the disabled portion, so as to correspond to a zenith direction of the image area.

10. The portable terminal apparatus according to claim 7,
wherein when a press to the disabled portion of the second operation unit is detected, the synchronous operation control unit switches the disabled portion and the enabled portion and moves the image area and the operation area such that the image area positionally corresponds to the disabled portion and such that the operation area positionally corresponds to the enabled portion.

11. The portable terminal apparatus according to claim 6,
wherein the second operation unit comprises a rotary selector, and
wherein when the operation area of the first operation unit positionally corresponds to the rotary selector, the synchronous operation control unit enables operation to the rotary selector.
